(19) United States
(12) Patent Application Publication
(10) Pub. No.: US 2015/0319620 A1
(43) Pub. Date: Nov. 5, 2015

(54) BASE STATION DEVICE, TERMINAL DEVICE, COMMUNICATION SYSTEM, TRANSMISSION METHOD, RECEPTION METHOD, COMMUNICATION METHOD AND INTEGRATED CIRCUIT

(71) Applicant: SHARP KABUSHIKI KAISHA, Osaka-shi, Osaka (JP)

(72) Inventors: Katsuya KATO, Osaka-shi, Osaka (JP); Takashi YOSHIMOTO, Osaka-shi, Osaka (JP); Ryota YAMADA, Osaka-shi, Osaka (JP); Kozue YOKOMAKURA, Osaka-shi, Osaka (JP)

(73) Assignee: Sharp Kabushiki Kaisha, Osaka-shi, Osaka (JP)

(21) Appl. No.: 14/648,436

(22) PCT Filed: Nov. 29, 2013
(86) PCT No.: PCT/JP2013/082279

§ 371 Date: May 29, 2015

(30) Foreign Application Priority Data
Nov. 30, 2012 (JP) 2012-261918

(51) Int. Cl. H04W 16/02; H04W 36/38; H04W 16/32; H04W 40/24; H04W 72/04

(52) U.S. Cl. CPC H04W 16/02; H04W 40/244; H04W 72/0426; H04W 16/32; H04W 36/38; H04W 88/02

(57) ABSTRACT

In a communication system including a first base station device, at least one second base station device that has smaller transmit power than that of the first base station device, and a terminal device that is connected with the first base station device or the second base station device, a transmission unit of the second base station device maps per one resource block a smaller number of reference signals than a number of reference signals mapped per one resource block by the first base station device and transmits the mapped reference signals.

### TECHNICAL FIELD

The present invention relates to a base station device, a terminal device, a communication system, a transmission method, a reception method, a communication method and an integrated circuit.

This application claims priority based on Japanese Patent Application No. 2012-261918 filed in Japan on Nov. 30, 2012, the content of which is incorporated herein.

### BACKGROUND ART

In radio communication systems like WCDMA (Wideband Code Division Multiple Access), LTE (Long Term Evolution) and LTE-A (LTE-Advanced) by 3GPP (3rd Generation Partnership Project), and WiMAX (Worldwide Interoperability for Microwave Access) by IEEE (The Institute of Electrical and Electronics engineers) and the like, a communication service area is formed by a cell configuration in which many base stations (transmission station, transmission device, eNodeB) are arranged. The cell refers to a range where the base stations are able to be connected with terminals (mobile terminal, reception station, mobile station, reception device, UE (User Equipment)).

In a system which is formed with this cell configuration (hereinafter, cellular system), with increase in a traffic volume due to increase of a large capacity service or the like, distribution of traffic is demanded. In order to meet this demand, it is proposed that a cellular system is configured to have such arrangement that, with one cell as a macro cell, a part or all of a range thereof is overlapped with a range of a small cell (such as a pica cell or a femto cell) which is a cell different from the macro cell (also called heterogeneous network deployment (HetNet) (NPL 1).

FIG. 18 is one example of the HetNet. A cell 1000-1a of FIG. 18 represents a macro cell. A cell 1000-2a and a cell 1000-3a represent small cells. A base station 1000-1 configures the macro cell 1000-1a. Hereinafter, the base station which configures the macro cell in this manner is called a macro cell base station (main base station). A base station 1000-2 configures a small cell 1000-2a. A base station 1000-3 configures a small cell 1000-3a. Hereinafter, the base stations which configure the small cells in this manner are called small cell base stations (low power base station, LPN: Low Power Node, pico cell base station, femto cell base station). The macro cell base station 1000-1 is connected with the small cell base stations 1000-2 and 1000-3 through lines 1000-2b and 1000-3b. The lines 1000-2b and 1000-3b may be optical fibers or other wired lines (for example, X2 interfaces), or radio links. A base station device exchanges desired control information or the like with a base station device which is connected through the line.

A plurality of terminal devices exist in a cell. In FIG. 18, a terminal device 2000-1 exists in the macro cell 1000-1a. A terminal device 2000-2 exists in the macro cell 1000-1a and in the small cell 1000-2a. A terminal device 2000-3 exists in the macro cell 1000-1a and in the small cell 1000-3a. At this time, by radio-connecting the terminal device 2000-1 with the macro cell base station 1000-1, by radio-connecting the terminal device 2000-2 with the small cell base station 1000-2, and by radio-connecting the terminal device 2000-3 with the small cell base station 1000-3, distribution of traffic is realized.

In the cellular system, a base station device transmits and receives various control information (control channel, control signal) to and from other base station devices and terminal devices. FIG. 19 is a conventional example of a transmission frame format in downlink of the cellular system. In FIG. 19, one transmission frame is configured by including ten sub-frames (sub-frame index #0 to sub-frame index #9).

In the frame format of FIG. 19, cell-specific reference signals (CRSs, hatched portions in the figure), downlink shared channels (PDSCHs; Physical Downlink Shared Channels, channels mainly for transmitting information data, white portions in the figure), downlink control channels (PDCCH; Physical Downlink Control Channels, intersection portions of right-rising oblique lines and left-rising oblique lines in the figure), synchronization signals (PSSs; Primary Synchronization Signals, right-rising oblique line portions in the figure, SSSs; Secondary Synchronization Signals, left-rising oblique line portions in the figure), and broadcast channels (PBCHs; Physical Broadcast Channels, grid portions in the figure) are mapped as downlink physical signals or physical channels.

The CRS is a signal used for channel estimation. The PDSCH is a channel mainly for transmitting information data. The PDCCH is a channel used mainly for notifying radio resource assignment information of a terminal device. The PSS is a signal used mainly for symbol timing synchronization. The SSS is a signal used for frame synchronization. The PBCH is a channel for transmitting control information which is desired for a terminal device to receive the PDSCH (for example, MIB; Master Information Block in LTE).

### CITATION LIST

### Non Patent Literature

NPL 1: 3rd Generation Partnership Project; Technical Specification Group Radio Access Network; Further Advancements for E-UTRA Physical Layer Aspects (Release 9), 3GPP TR36.814 v9.0.0 (March, 2010), URL: http://www.3gpp.org/ftp/Specs/html-info/36814.htm

### SUMMARY OF INVENTION

### Technical Problem

However, a small cell typically has a smaller coverage and has a different communication environment compared to a macro cell. Accordingly, transmission efficiency is reduced in some cases where the small cell uses the frame format same as that of the macro cell like in FIG. 19.

The present invention has been made in view of the aforementioned problems, and an object thereof is to provide a base station device, a terminal device, a communication system, a transmission method, a reception method, a communication method and an integrated circuit, capable of improving transmission efficiency by configuring a frame format of a small cell to be suitable for the small cell.

### Solution to Problem

In order to solve the problems described above, a base station device, a terminal device, a communication system, a transmission method, a reception method, a communication method and an integrated circuit according to the present invention are configured as follows.

(1) A base station device according to one aspect of the present invention is a second base station device of a communication system including a first base station device, at least one of the second base station device that has smaller transmit power than that of the first base station device, and a terminal device that is connected with the first base station device or the second base station device, in which a number of reference signals mapped per one resource block by the second base station device is less than a number of reference signals mapped per one resource block by the first base station device.

(2) Moreover, a base station device according to one aspect of the present invention is the aforementioned second base station device, in which the reference signals mapped by the second base station device may be user-specific reference signals, and the number of the reference signals mapped per one resource block by the second base station device may be less than a number of user-specific reference signals mapped per one resource block by the first base station device.

(3) Moreover, a base station device according to one aspect of the present invention is the aforementioned second base station device, in which the reference signals mapped by the second base station device may be cell-specific reference signals, and the number of the reference signals mapped by the second base station device may be less than a number of cell-specific reference signals mapped by the first base station device.

(4) Moreover, a base station device according to one aspect of the present invention is the aforementioned second base station device, in which a frequency interval of the reference signals mapped by the second base station device may be wider than a frequency interval of the reference signals mapped by the first base station device.

(5) Moreover, a base station device according to one aspect of the present invention is the aforementioned second base station device, in which a time interval of the reference signals mapped by the second base station device may be wider than a time interval of the reference signals mapped by the first base station device.

(6) Moreover, a base station device according to one aspect of the present invention is the aforementioned second base station device, in which the second base station device may be configured so as to further perform mapping for cell-specific reference signals in addition to the user-specific reference signals.

(7) Moreover, a base station device according to one aspect of the present invention is the aforementioned second base station device, in which the second base station device may be configured so as to further perform mapping for user-specific reference signals in addition to the cell-specific reference signals.

(8) A terminal device according to one aspect of the present invention is a terminal device of a communication system including a first base station device, at least one second base station device that has smaller transmit power than that of the first base station device, and the terminal device that is connected with the first base station device or the second base station device, including a control information detection unit that receives arrangement information of reference signals transmitted by the second base station device from the first base station device; and a channel estimation unit that calculates a channel estimation value based on the arrangement information and the reference signals transmitted by the second base station device.

(9) A terminal device according to one aspect of the present invention is the aforementioned terminal device, which may be configured such that identification information indicating whether the reference signals transmitted by the second base station device are user-specific reference signals or cell-specific reference signals is received from the first base station device.

(10) A terminal device according to one aspect of the present invention is a terminal device of a communication system including a first base station device, at least one second base station device that has smaller transmit power than that of the first base station device, and the terminal device that is connected with the first base station device or the second base station device, in which a number of reference signals mapped per one resource block to be addressed to the second base station device is less than a number of reference signals mapped per one resource block to be addressed to the first base station device.

(11) A communication system according to one aspect of the present invention is a communication system including a first base station device, at least one second base station device that has smaller transmit power than that of the first base station device, and a terminal device that is connected with the first base station device or the second base station device, in which a number of reference signals mapped per one resource block by the second base station device is less than a number of reference signals mapped per one resource block by the first base station device, and the terminal device includes a control information detection unit that receives arrangement information of the reference signals transmitted by the second base station device from the first base station device; and a channel estimation unit that calculates a channel estimation value based on the reference signals transmitted by the second base station device.

(12) A transmission method according to one aspect of the present invention is a transmission method of a second base station device of a communication system including a first base station device, at least one of the second base station device that has smaller transmit power than that of the first base station device, and a terminal device that is connected with the first base station device or the second base station device, in which a number of reference signals mapped per one resource block by the second base station device is less than a number of reference signals mapped per one resource block by the first base station device.

(13) A reception method according to one aspect of the present invention is a reception method of a terminal device of a communication system including a first base station device, at least one second base station device that has smaller transmit power than that of the first base station device, and the terminal device that is connected with the first base station device or the second base station device, in which the terminal device includes a control information detection step of receiving arrangement information of reference signals transmitted by the second base station device from the first base station device; and a channel estimation step of calculating a channel estimation value based on the arrangement information and the reference signals transmitted by the second base station device.

(14) A reception method according to one aspect of the present invention is a reception method of a terminal device of a communication system including a first base station device, at least one second base station device that has smaller transmit power than that of the first base station device, and the terminal device that is connected with the first base station device or the second base station device, in which a number of reference signals mapped per one resource block to be addressed to the second base station device by the terminal device is less than a number of reference signals mapped per one resource block to be addressed to the first base station device.

(15) A communication method according to one aspect of the present invention is a communication method of a communication system including a first base station device, at least one second base station device that has smaller transmit power than that of the first base station device, and a terminal device that is connected with the first base station device or the second base station device, in which a number of reference signals mapped per one resource block by the second base station device is less than a number of reference signals mapped per one resource block by the first base station device, and the terminal device includes a control information detection step of receiving arrangement information of the reference signals transmitted by the second base station device from the first base station device; and a channel estimation step of calculating a channel estimation value based on the reference signals transmitted by the second base station device.

(16) An integrated circuit according to one aspect of the present invention is an integrated circuit of a second base station device of a communication system including a first base station device, at least one of the second base station device that has smaller transmit power than that of the first base station device, and a terminal device that is connected with the first base station device or the second base station device, in which a number of reference signals mapped per one resource block by the second base station device is less than a number of reference signals mapped per one resource block by the first base station device.

(17) An integrated circuit according to one aspect of the present invention is an integrated circuit of a terminal device of a communication system including a first base station device, at least one second base station device that has smaller transmit power than that of the first base station device, and the terminal device that is connected with the first base station device or the second base station device, in which the terminal device has a control information detection function of receiving arrangement information of reference signals transmitted by the second base station device from the first base station device; and a channel estimation function of calculating a channel estimation value based on the arrangement information and the reference signals transmitted by the second base station device.

(18) An integrated circuit according to one aspect of the present invention is an integrated circuit of a terminal device of a communication system including a first base station device, at least one second base station device that has smaller transmit power than that of the first base station device, and the terminal device that is connected with the first base station device or the second base station device, in which a number of reference signals mapped per one resource block to be addressed to the second base station device by the terminal device is less than a number of reference signals mapped per one resource block to be addressed to the first base station device.

(19) An integrated circuit according to one aspect of the present invention is an integrated circuit of a communication system including a first base station device, at least one second base station device that has smaller transmit power than that of the first base station device, and a terminal device that is connected with the first base station device or the second base station device, in which a number of reference signals mapped per one resource block by the second base station device is less than a number of reference signals mapped per one resource block by the first base station device, and the terminal device has a control information detection function of receiving arrangement information of the reference signals transmitted by the second base station device from the first base station device; and a channel estimation function of calculating a channel estimation value based on the reference signals transmitted by the second base station device.

### Advantageous Effects of Invention

According to the aspects of the present invention, in a communication system including a first base station device, at least one second base station device that has smaller transmit power than that of the first base station device, and a terminal device that is connected with the first base station device or the second base station device, a number of reference signals mapped per one resource block by the second base station device is made less than a number of reference signals mapped per one resource block by the first base station device, thus making it possible to improve transmission efficiency.

### BRIEF DESCRIPTION OF DRAWINGS

FIG. 1 is a schematic view showing a configuration example of a communication system in a first embodiment of the present invention;

FIG. 2 is one aspect of a resource block configuring a downlink transmission format which is transmitted by a macro cell base station 100-1 according to the first embodiment of the present invention;

FIG. 3 is a schematic view showing arrangement of cell-specific reference signals in a resource block according to the first embodiment of the present invention;

FIG. 4 is one aspect of a downlink transmission format which is transmitted by a small cell base station 100-2 according to the first embodiment of the present invention;

FIG. 5 is another one aspect of the downlink transmission format which is transmitted by the small cell base station 100-2 according to the first embodiment of the present invention;

FIG. 6 is another one aspect of the downlink transmission format which is transmitted by the small cell base station 100-2 according to the first embodiment of the present invention;

FIG. 7 is one example of a sequence diagram showing a flow of processing of the communication system in the first embodiment of the present invention;

FIG. 8 is a schematic block diagram showing a configuration of the macro cell base station 100-1 according to the first embodiment of the present invention;

FIG. 9 is a schematic block diagram showing a configuration of the small cell base station 100-2 according to the first embodiment of the present invention;

FIG. 10 is a schematic block diagram showing a configuration of a terminal 200 according to the first embodiment of the present invention;

FIG. 11 is a schematic view showing one example of a format of a resource block which is transmitted by a small cell base station 100-3 according to a second embodiment of the present invention;

FIG. 12 is a schematic view showing another one example of the format of the resource block which is transmitted by the small cell base station 100-3 according to the second embodiment of the present invention;

FIG. 13 is a schematic view showing one example of a resource block in a case where the number of transmit antennas that cell-specific reference signals are able to deal with is increased up to eight;

FIG. 14 is a schematic block diagram showing a configuration of the small cell base station 100-3 according to the second embodiment of the present invention;

FIG. 15 is a schematic block diagram showing a configuration of a terminal 300 according to the second embodiment of the present invention;

FIG. 16 is a sequence diagram showing a flow of processing of a communication system in the second embodiment of the present invention;

FIG. 17 is a schematic block diagram showing a configuration of a terminal 400 according to the second embodiment of the present invention;

FIG. 18 is one example of a heterogeneous network; and

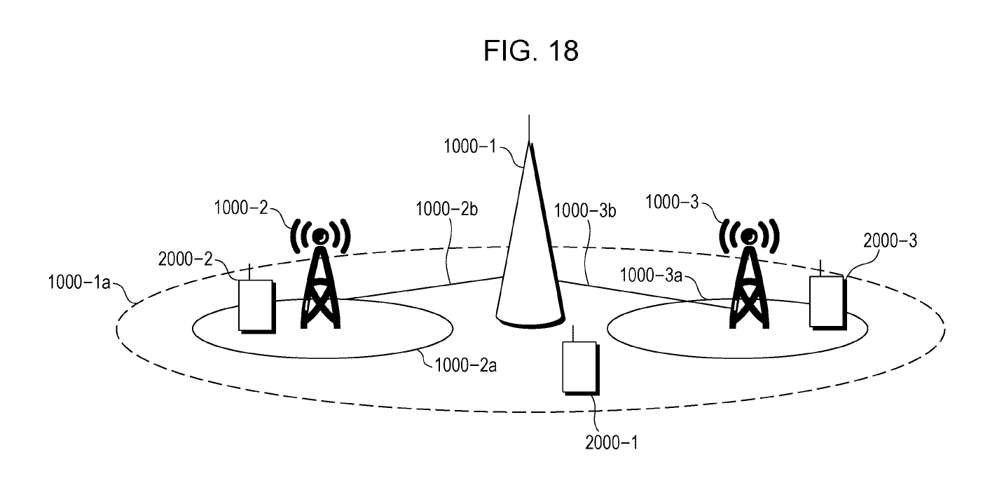

FIG. 19 is a conventional example of a transmission frame format in downlink of a cellular system.

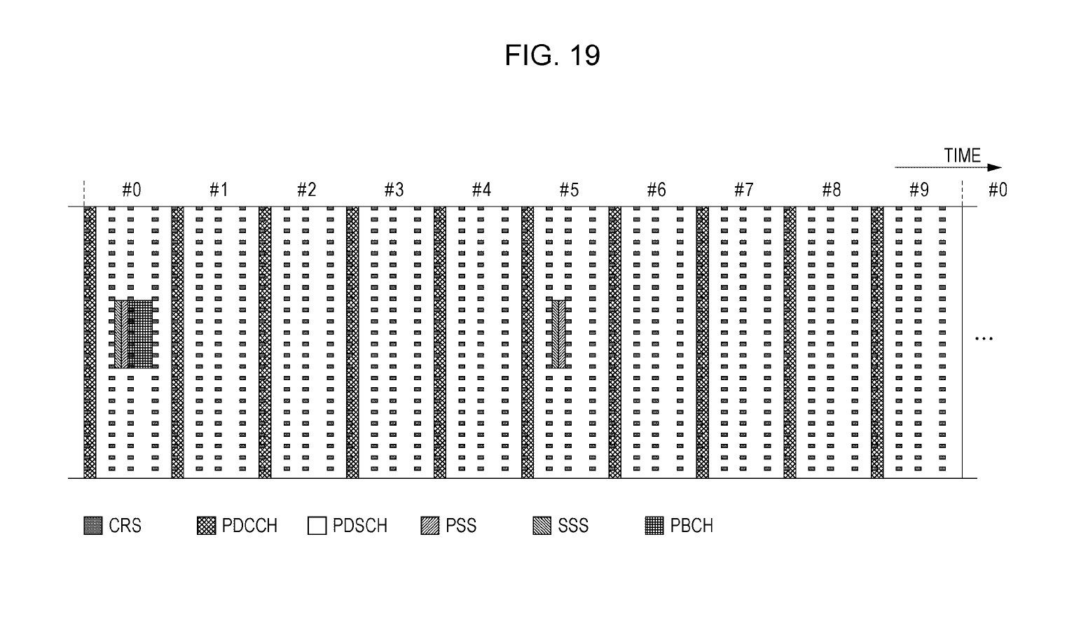

### DESCRIPTION OF EMBODIMENTS

Description will hereinafter be given for embodiments of the present invention with reference to accompanying drawings.

Description will be given in embodiments below for an example that base station devices (eNodeB, transmission station, transmission device, transmission point, access point (AP)) and terminal devices (terminal, mobile station device, mobile terminal, reception point, reception terminal, reception device, UE: User Equipment) which configure a communication system perform data transmission by using an OFDM (Orthogonal Frequency Division Multiplexing) scheme. In the embodiments below, however, other transmission schemes, for example, including a single carrier transmission scheme such as narrowband single carrier transmission, SC-FDMA (Single Carrier-Frequency Division Multiple Access) or DFT-s-OFDM (Discrete Fourier Transform-spread-OFDM), and a multi-carrier transmission scheme such as MC-CDMA (Multiple Carrier-Code Division Multiple Access) may be used. Moreover, the communication system according to the embodiments of the present invention includes radio communication systems, as example, like WCDMA (Wideband Code Division Multiple Access), LTE (Long Term Evolution) and LTE-A (LTE-Advanced) by 3GPP (3rd Generation Partnership Project), or WiMAX (Worldwide Interoperability for Microwave Access) by IEEE (The Institute of Electrical and Electronics engineers) and the like, but is not limited thereto.

### First Embodiment

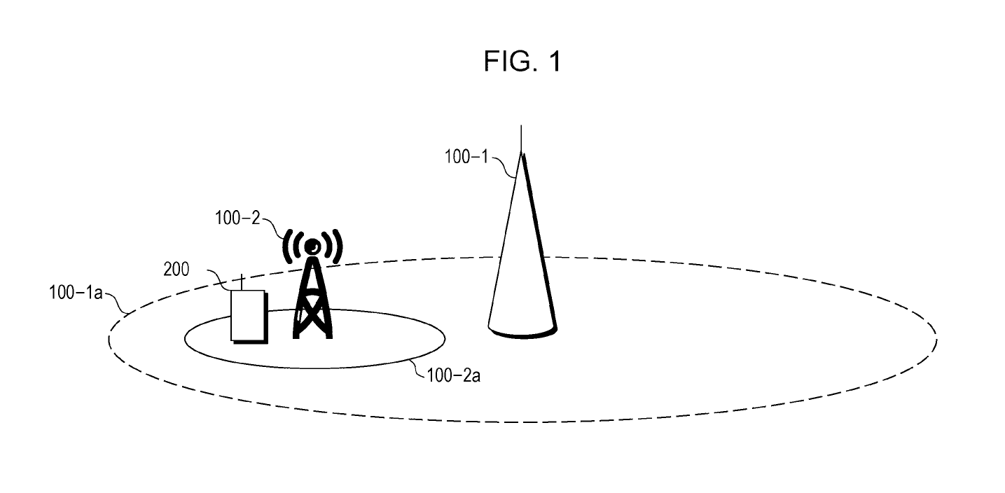

Description will be given below for a first embodiment of the present invention. FIG. 1 is a schematic view showing a configuration example of a communication system in the first embodiment. FIG. 1 shows one example of the communication system in the present embodiment in a case where a small cell 100-2a configured by a small cell base station (low power base station, LPN: Low Power Node, pico cell base station, femto cell base station, second base station device) 100-2 exists in a macro cell 100-1a configured by a macro cell base station (main base station, first base station device) 100-1. The small cell base station and the small cell may not be one. A part or all of the small cell may be beyond the macro cell. The macro cell base station and the small cell base station may be the same base station. Moreover, a terminal 200 is assumed to be connected with the small cell base station 100-2 in FIG. 1.

Though the communication system of FIG. 1 is premised as one example in the present embodiment, the present embodiment is applicable to any communication system as long as having at least one small cell arranged in the macro cell. Accordingly, the number of cells, the number of base stations, the number of terminals, types of cells (for example, such as a pico cell and a femto cell), types of base stations and the like are not limited to the present embodiment.

The small cell base station is able to serve as a base station having smaller transmit power than that of the macro cell base station. For discrimination between the small cell base station and the macro cell base station, the discrimination may be performed between a cell having backward compatibility which supports a scheme that has already performed service in and a cell having no backward compatibility, which is newly defined.

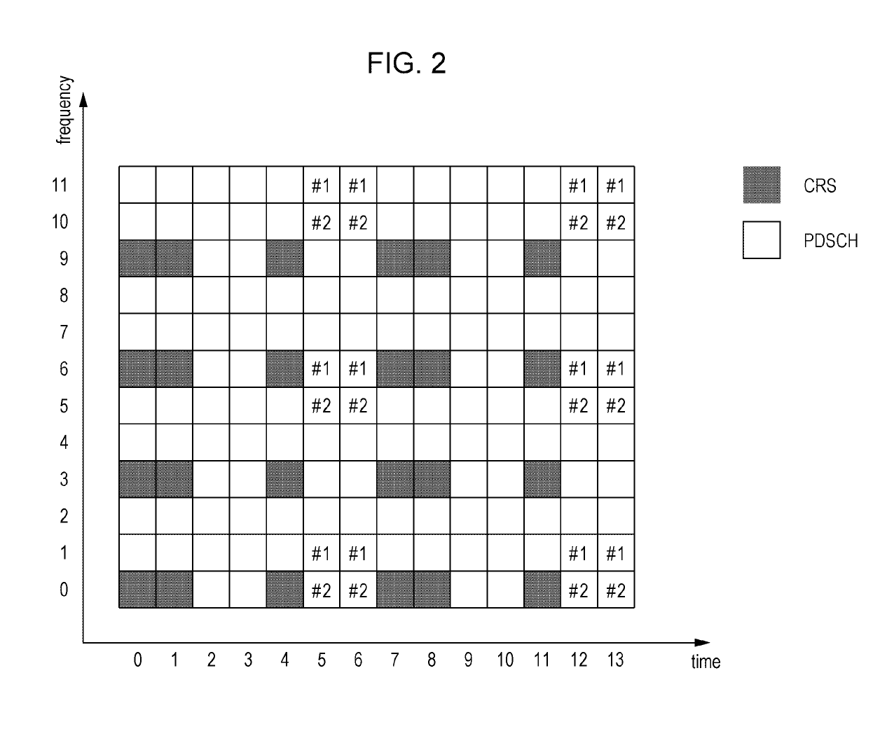

FIG. 2 is one aspect of an RB (Resource Block) configuring a downlink transmission format which is transmitted by the macro cell base station 100-1 according to the first embodiment. Here, the RB is a unit configured by fourteen and twelve REs (Resource Elements) in a time direction and a frequency direction, respectively. The RE refers to a minimum unit in which a signal is arranged, and refers to a unit in which a signal composed of one sub-carrier and one OFDM symbol is arranged in OFDM transmission. FIG. 2 shows the RB which includes only a CRS (Cell-specific Reference Signal) and a PDSCH (Physical Downlink Shared Channel). Note that, there may be the RB which includes a PDCCH (Physical Downlink Control Channel), a PSS (Primary Synchronization Signal) and an SSS (Secondary Synchronization Signal) which are synchronization signals, and a PBCH (Physical Broadcast Channel).

In FIG. 2, the REs indicated by #1 and #2 are REs in which a user-specific reference signal is arranged. As the user-specific reference signal, for example, a DMRS (DeModulation Reference Signal; UE-specific Reference Signal) is usable. The DMRS is used by a terminal which performs communication with the macro cell base station in order to perform channel estimation for demodulation.

For example, in a sub-carrier with a frequency number 11 of FIG. 2, reference signals are able to be multiplexed up to four streams by using four DMRSs of #1. Code multiplexing is usable for multiplexing the four reference signals. Multiplexing of the reference signals is able to be performed up to eight streams by using both #1 and #2.

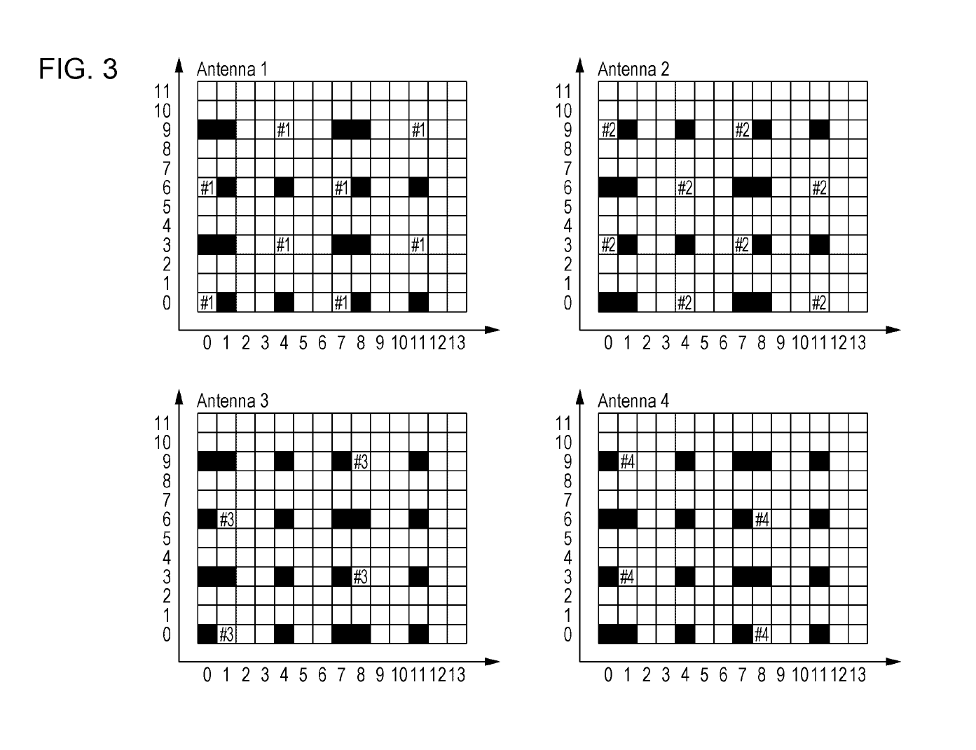

FIG. 3 is a schematic view showing arrangement of CRSs in one RB according to the present embodiment. #x (x=1, 2, 3, 4) indicates the reference signal of an x-th transmit antenna provided in the small cell base station 100-2. A solid indicates to transmit a null (transmit nothing). This makes it possible to perform channel estimation of a channel from each transmit antenna on a terminal side. In a case where the terminal limits multiplexing of the transmit antenna up to four, the channel estimation may be performed by using not the DMRSs but the CRSs.

Note that, in a case where the number of the transmit antennas provided in the macro cell base station is smaller than four, positions of the null may be less. In the present embodiment, description will be given on the assumption that the terminal 200 uses not the CRSs but the DMRSs. Note that, the CRSs are arranged in an entire band of the system regardless of a user.

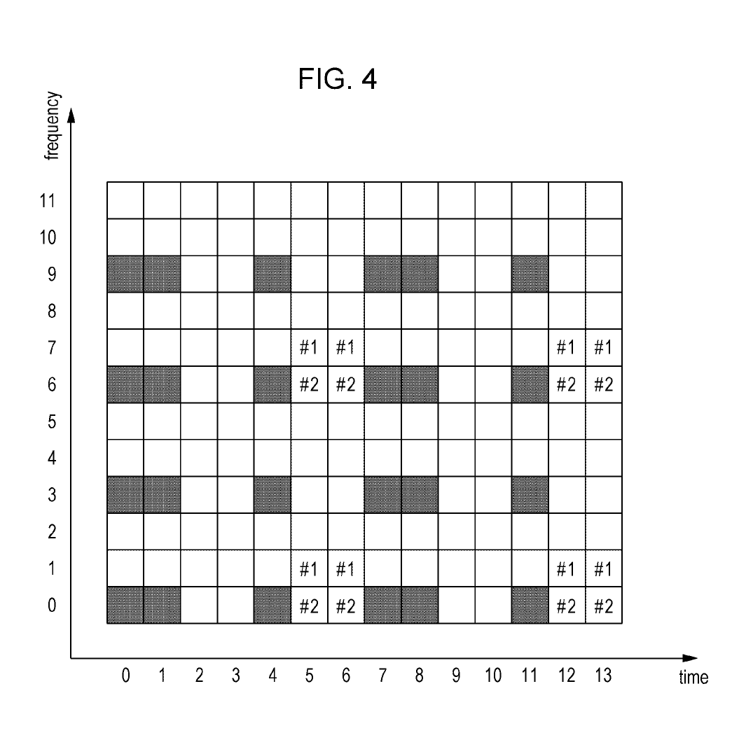

FIG. 4 is one aspect of a downlink transmission format which is transmitted by the small cell base station 100-2 according to the first embodiment. FIG. 4 shows one RB in the same manner as FIG. 2. In FIG. 4, differently from FIG. 2, two DMRSs are arranged in a frequency direction as indicated with #1 and #2. By making a frequency interval of the RSs wider in this manner, it is possible to significantly improve transmission efficiency of transmission signals from the small cell base station 100-2. It is expected that the small cell has a smaller coverage compared to that of the macro cell and does not cause a long delay wave. In this case, accuracy of channel estimation is hardly deteriorated even arrangement of the reference signals like in FIG. 4 is used.

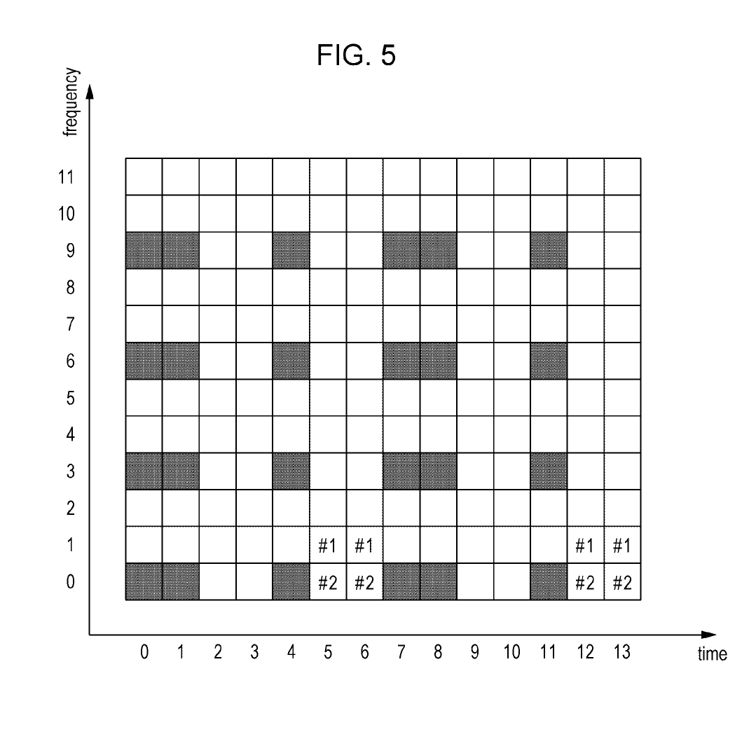

FIG. 5 is another one aspect of the downlink transmission format which is transmitted by the small cell base station 100-2 according to the first embodiment. The arrangement number of frequencies of the DMRSs indicated by #1 and #2 is one and the frequency interval of the RS is made wider in FIG. 5. The arrangement number of frequencies is able to be determined according to a land form where the small cell base station 100-2 is installed, and in the case of installing in a place where only a short delay wave is caused, the arrangement number of frequencies is able to be reduced. Note that, an arrangement position may not be matched with those of FIG. 4 and FIG. 5, and #1 may be arranged in frequency numbers 1 and 11, for example.

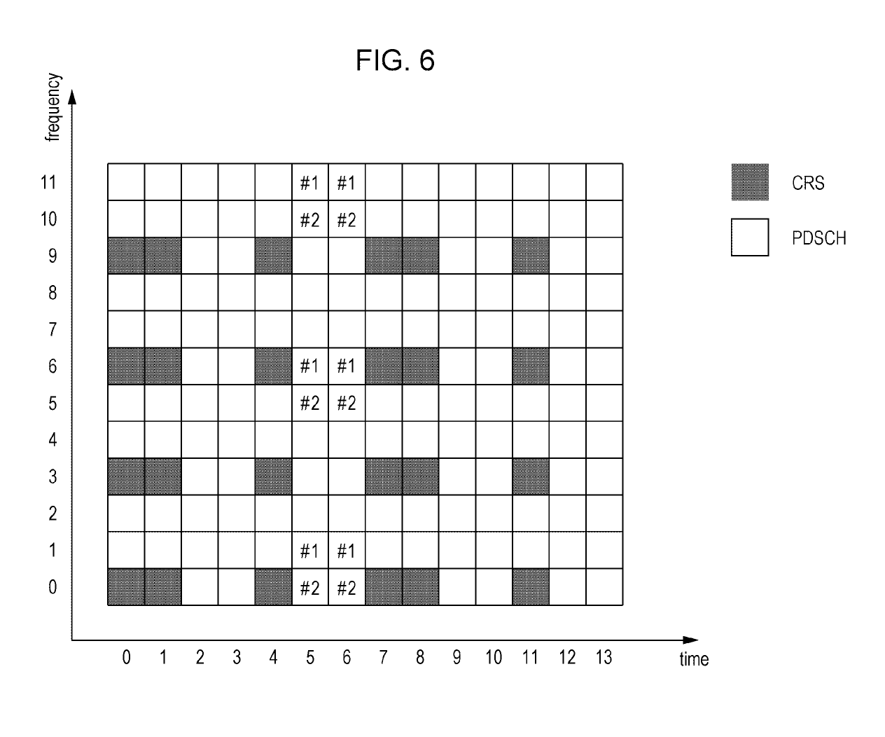

FIG. 6 is another one aspect of the downlink transmission format which is transmitted by the small cell base station 100-2 according to the first embodiment. In FIG. 6, the arrangement number of the DMRSs per one frequency is two and the time interval of RS arrangement is made wider.

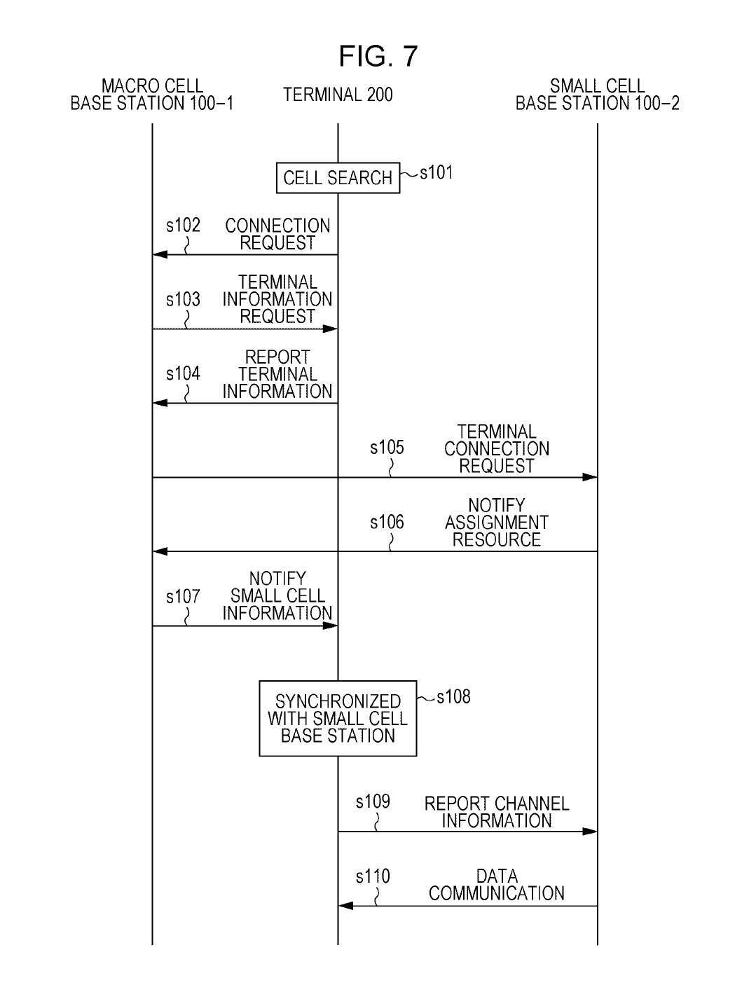

FIG. 7 is one example of a sequence diagram showing a flow of processing of the communication system in the first embodiment. FIG. 7 is processing until the terminal 200 is connected with the small cell base station 100-2 to start data communication with the small cell base station 100-2. The terminal 200 performs cell search for detecting a connection destination from a plurality of macro cell base stations (s101). Assume that the terminal 200 selects the macro cell base station 100-1 as the connection destination.

The terminal 200 makes a connection request to the macro cell base station 100-1 (s102). Upon receiving the connection request from the terminal 200, the macro cell base station 100-1 transmits a terminal information request to the terminal 200 (s103). Here, the terminal information is information for judging whether to cause the terminal 200 to be connected with a small cell surrounding the terminal 200 or a macro cell. For example, the terminal information may be a position of the terminal 200, and the macro cell base station 100-1 may determine the connection destination of the terminal 200 based on a distance between the terminal 200 and the surrounding small cell base station. For example, the terminal information may be electric power of the surrounding small cell, which is measured by the terminal 200, and the macro cell base station 100-1 may determine the connection destination of the terminal 200 based on the electric power. Upon receiving the terminal information request, the terminal 200 reports the terminal information to the macro cell base station 100-1 (s104). The macro cell base station 100-1 determines the connection destination of the terminal 200 based on the received terminal information.

Here, description will be given for a case where the macro cell base station 100-1 instructs the terminal 200 to be connected with the small cell base station 100-2. The macro cell base station 100-1 transmits a terminal connection request to the small cell base station 100-2 (s105). The small cell base station 100-2 notifies the macro cell base station 100-1 of an RB for connecting the terminal 200 with the small cell base station 100-2 (s106). The macro cell base station 100-1 notifies the terminal 200 of small cell information which includes the RB and a position of the DMRS in the RB (s107). The terminal 200 is synchronized with the small cell base station 100-2 based on the notified small cell information (s108). The terminal 200 reports channel information to the small cell base station 100-2 (s109). Here, the channel information includes a channel estimation value, a channel quality indicator (CQI), and a rank of an MIMO channel, and the small cell base station 100-2 performs data communication with the terminal 200 based on the notified channel information (s110).

Note that, a known signal which is included in reception signals from the small cell base station 100-2 may be used for channel estimation and CQI measurement. For example, the small cell base station 100-2 transmits a CSI-RS (Channel State Information-Reference Signal, reference signal for measurement) as the known signal, and the terminal 200 is able to use the CSI-RS. Alternatively, the PSS and the SSS included in the reception signals from the small cell base station 100-2 are usable. Alternatively, the CRS included in the reception signals from the small cell base station 100-2 is usable.

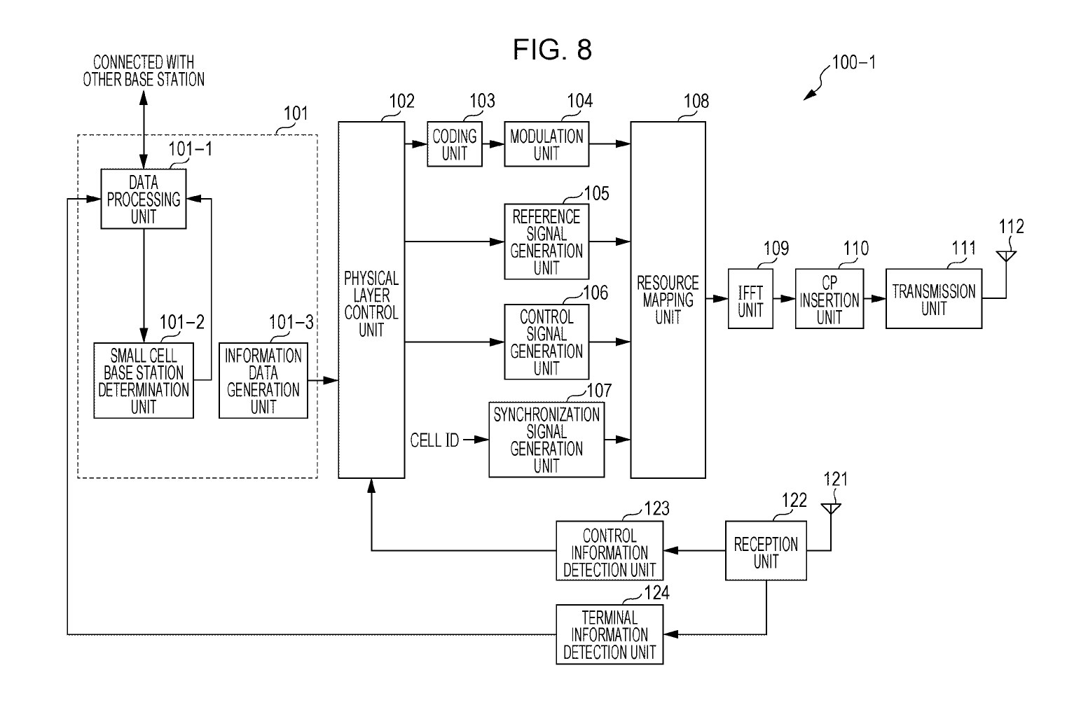

FIG. 8 is a schematic block diagram showing a configuration of the macro cell base station 100-1 according to the present embodiment. The macro cell base station 100-1 is configured by including a data processing unit 101-1, a small cell base station determination unit 101-2, an information data generation unit 101-3, a physical layer control unit 102, a coding unit 103, a modulation unit 104, a reference signal 105, a control signal generation unit 106, a synchronization signal generation unit 107, a resource mapping unit 108, an IFFT (Inverse Fast Fourier Transform) unit 109, a CP (Cyclic Prefix) insertion unit 110, a transmission unit 111, a transmit antenna 112, a receive antenna 121, a reception unit 122, a control information detection unit 123, and an information data detection unit 124. Note that, the data processing unit 101-1, the small cell base station determination unit 101-2 and the information data generation unit 101-3 are also referred to as a higher layer 101. Moreover, in the case where a part or all of the aforementioned macro cell base station 100-1 is chipped to serve as an integrated circuit, a chip control circuit (not shown) which performs control for each functional block is included. Note that, the numbers of transmit antennas and receive antennas are set as one in FIG. 8, but the number of antennas may be plural.

In uplink, the macro cell base station 100-1 receives transmission signals from the terminal 200 through the receive antenna 121. Here, the signals received by the macro cell base station 100-1 include a control signal, an uplink data signal and the like.

The control signal includes information regarding a parameter of the transmission signals transmitted by the macro cell base station 100-1 in downlink and the like. Information regarding a CQI, rank number/spatial multiplexing number of MIMO transmission (RI; Rank Indicator) and other downlink scheduling, or the like corresponds to the information regarding the parameter of the transmission signals. The schedule refers to determining at what time (timing) which frequency band is to be used for transmission in the case of transmitting certain data. The scheduling information refers to information regarding the time and the frequency band which are determined. For example, it refers to determining to which RB information data or the like is assigned in the LTE and the LTE-A. Note that, the control signal is transmitted by using an uplink control channel (PUCCH; Physical Uplink Control Channel) or the like.

The uplink data signal includes information desired by the higher layer 101. In the present embodiment, reception quality is included in the uplink data signal. Note that, the control signal of the higher layer 101 is transmitted by using an uplink shared channel (PUSCH; Physical Uplink Shared Channel) or the like.

The reception unit 122 down-converts the reception signals to a frequency band which is able to be subjected to digital signal processing such as signal detection processing (radio frequency conversion) and performs filtering processing. Moreover, the reception unit 122 applies analog to digital conversion (A/D conversion) to the signals subjected to the filtering processing, outputs the control signal to the control information detection unit 123, and outputs the uplink data signal to the terminal information detection unit 124.

The control information detection unit 123 performs demodulation and decoding processing or the like for the control signal which is input from the reception unit 122, and detects control information to output to the physical layer control unit 102.

The terminal information detection unit 124 performs demodulation and decoding processing for the uplink data signal which is input from the reception unit 122, and detects terminal information from uplink information data to output to the data processing unit 101-1 of the higher layer 101.

The higher layer 101 transmits and receives data of other base stations which are connected through a backhaul line. Here, it is assumed that the higher layer 101 includes an RRC (Radio Resource Control) layer.

The data processing unit 101-1 performs processing of data acquired by the higher layer 101. First, the data processing unit 101-1 outputs the terminal information to the small cell base station determination unit 101-2 based on the terminal information input from the terminal information detection unit 124. In the present embodiment, description will be given on the assumption that the terminal information of the terminal 200 is processed.

The small cell base station determination unit 101-2 determines a small cell base station to be connected with the terminal 200 based on the terminal information input from the data processing unit 101-1. In the present embodiment, description will be given on the assumption that the small cell base station 100-2 is determined. The small cell base station determination unit 101-2 outputs information of the determined small cell base station to the data processing unit 101-1.

The data processing unit 101-1 transmits a terminal connection request to the small cell base station 100-2 through the backhaul line based on the information of the small cell base station which is input from the small cell base station determination unit 101-2 (step s105 of FIG. 7).

The information data generation unit 101-3 converts data which is transmitted from the macro cell base station 100-1 to the terminal 200 (transmission data) into a predefined signal format to serve as downlink information data. Here, the downlink information data includes data which is transferred from an MAC (Medium Access Control) layer to a physical layer and a parameter which is set in the RRC layer for controlling the parameter thereof. Moreover, the information data generation unit 101-3 outputs the downlink information data to the physical layer control unit 102.

The physical layer control unit 102 outputs the downlink information data which is input from the information data generation unit 101-3 to the coding unit 103. Moreover, the physical layer control unit 102 determines a generation pattern of the reference signals based on the control information which is input from the control information detection unit 123, and outputs the generation pattern of the reference signals to the reference signal generation unit 105. Further, the physical layer control unit 102 outputs the control information which is input from the control information detection unit 123 to the control signal generation unit 106.

The coding unit 103 performs error correction coding for the downlink information data which is input from the physical layer control unit 102. Specifically, the coding unit 103 uses turbo coding, convolutional coding, low density parity check coding (LDPC) or the like. Note that, the coding unit 103 may perform rate matching processing for a coding bit sequence so that a coding rate of coding data is matched with a coding rate corresponding to a data transmission rate. Further, the coding unit 103 may have a function of interleaving the coding data sequence.

The modulation unit 104 modulates the coding bit sequence which is input from the coding unit 103 to generate a modulation symbol. Specifically, the modulation unit 104 uses BPSK (Binary Phase Shift Keying), QPSK (Quadrature Phase Shift Keying), QAM (Quadrature Amplitude Modulation) or the like. Note that, the modulation unit 104 may have a function of interleaving the generated modulation symbol.

The reference signal generation unit 105 generates the DMRS from the generation pattern of the reference signals input from the physical layer control unit 102, and outputs the generated DMRS to the resource mapping unit 108. Moreover, the reference signal generation unit 105 generates the CRSs and outputs the generated CRSs to the resource mapping unit 108.

The control signal generation unit 106 generates the control signal from the control information which is input from the physical layer control unit 102. Note that, error correction coding and modulation processing may be applied to the control signal.

The synchronization signal generation unit 107 generates the synchronization signal based on a cell ID of own station. This corresponds to the PSS and the SSS.

The resource mapping unit 108 performs mapping for the modulation symbol, the reference signal, the control signal and the synchronization signal into REs based on resource assignment information which is generated by the control information generation unit 106.

The IFFT unit 109 performs IFFT for a frequency region signal which is input from the resource mapping unit 108 to generate a signal in a time region.

The CP insertion unit 110 generates an OFDM symbol by adding a CP to a time region signal (also called effective symbol) which is input from the IFFT unit 109. The CP is a copy of a part of a backward portion of the effective symbol, and the OFDM symbol is generated by adding the aforementioned copy to a frontward portion of the effective symbol. Note that, periodicity may merely be maintained, and a copy of a part of the frontward portion of the effective symbol may be added to the backward portion of the effective symbol, etc. Moreover, the CP may be a known signal sequence.

The transmission unit 111 performs digital to analog conversion (D/A conversion) for the OFDM symbol which is input from the CP insertion unit 110 and generates an analog signal. The transmission unit 111 applies a band limit to the generated analog signal by filtering processing. The transmission unit 111 up-converts the analog signal to which the band limit is applied into a radio frequency band to transmit from the transmit antenna 112.

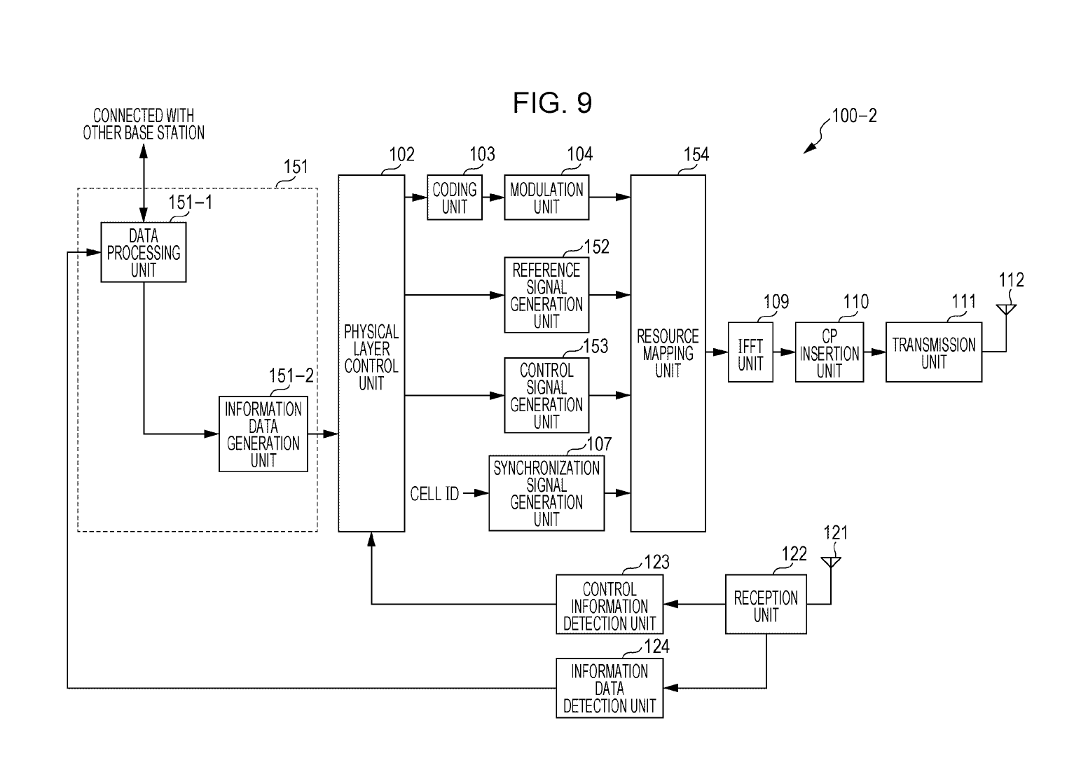

FIG. 9 is a schematic block diagram showing a configuration of the small cell base station 100-2 according to the present embodiment. Comparing the small cell base station 100-2 (FIG. 9) with the macro cell base station 100-1 (FIG. 8), a higher layer 151 is provided instead of the higher layer 101, and a reference signal generation unit 152, a control signal generation unit 153 and a resource mapping unit 154 operate differently. Functions included in other blocks are the same as those in FIG. 8. As to FIG. 9, description will be given mainly for operation different from that of FIG. 8.

A data processing unit 151-1 receives the terminal connection request from the macro cell base station 100-1 through the backhaul line (step s105 of FIG. 7). Moreover, the data processing unit 151-1 prepares an assignment resource according to the request, and notifies the macro cell base station 100-1 of the assignment resource (step s106 of FIG. 7).

An information data generation unit 151-1 converts data to be transmitted from the small cell base station 100-2 to the terminal 200 (transmission data) into a predefined signal format to serve as downlink information data. The information data generation unit 101-3 outputs the downlink information data to the physical layer control unit 102.

The reference signal generation unit 152 generates the DMRS to be arranged in the RB assigned to the terminal 200. The reference signal generation unit 152 outputs the generated DMRS to the resource mapping unit 154. The reference signal generation unit 152 outputs the CRS to the resource mapping unit 154.

The control signal generation unit 153 has a function of transmitting information indicating a position of the DMRS in the RB, in addition to the function included in the control signal generation unit 106 (FIG. 8).

The resource mapping unit 154 performs mapping for the modulation symbol, the reference signal, the control signal and the synchronization signal into REs based on resource assignment information which is generated by the control information generation unit 153. Here, the resource mapping unit 154 arranges the less number of DMRSs than the DMRSs transmitted by the macro cell base station 100-1, thus making it possible to increase resources used for data transmission and improve transmission efficiency.

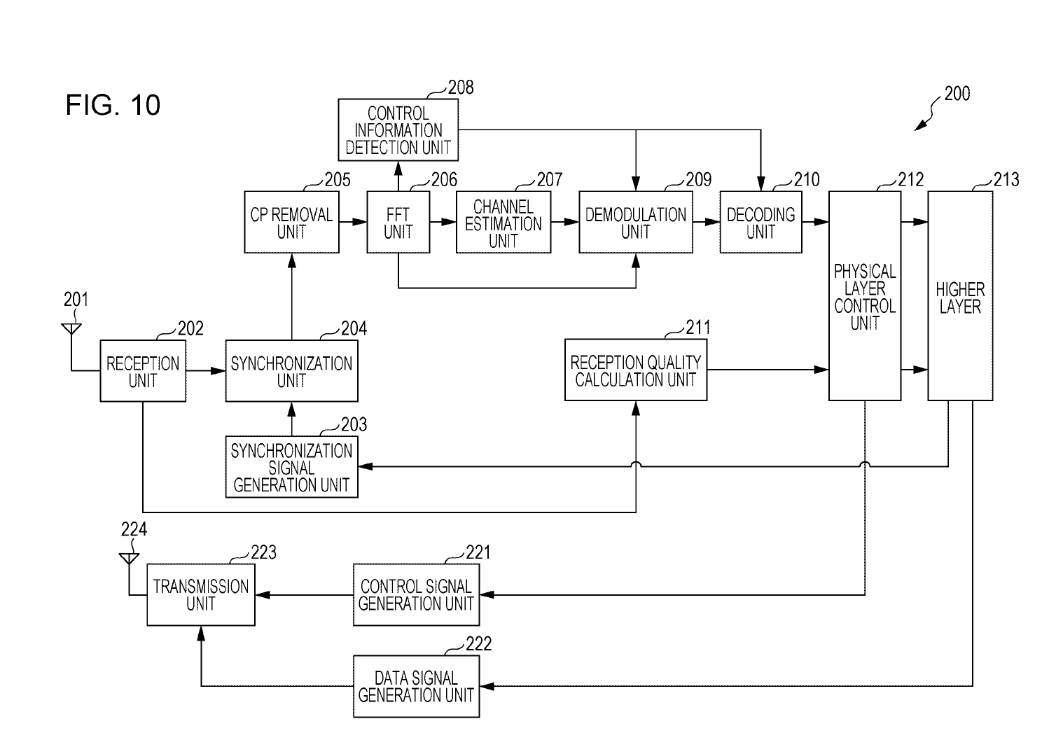

FIG. 10 is a schematic block diagram showing a configuration of the terminal 200 according to the present embodiment. The terminal 200 is configured by including a receive antenna 201, a reception unit 202, a synchronization signal generation unit 203, a synchronization unit 204, a CP removal unit 205, an FFT (Fast Fourier transform) unit 206, a channel estimation unit 207, a control information detection unit 208, a demodulation unit 209, a decoding unit 210, a reception quality calculation unit 211, a physical layer control unit 212, a higher layer 213, a control signal generation unit 221, a data signal generation unit 222, a transmission unit 223, and a transmit antenna 224. Note that, in the case where a part or all of the aforementioned terminal 200 is chipped to serve as an integrated circuit, a chip control circuit (not shown) which performs control for each functional block is included. Note that, the numbers of transmit antennas and receive antennas are set as one in FIG. 10, but the number of antennas may be plural.

The terminal 200 receives transmission signals from the macro cell base station 100-1 and the small cell base station 100-2 through the receive antenna 201.

The reception unit 202 down-converts a radio frequency signal which is input from the receive antenna 201 to a frequency band which is able to be subjected to digital signal processing and performs filtering processing. Further, the reception unit 202 applies A/D conversion to the signal subjected to the filtering processing, and outputs the converted digital signal to the synchronization unit 204.

The synchronization signal generation unit 203 generates the synchronization signal corresponding to the base station which performs synchronization.

The synchronization unit 204 performs synchronization processing with the macro cell base station 100-1 or the small cell base station 100-2 based on the synchronization signal which is input from the synchronization signal generation unit 203. As the synchronization signal used for synchronization with the macro cell base station 100-1, the PSS and the SSS are usable. The PSS and the SSS are usable also for synchronization with the small cell base station 100-2.

Note that, the synchronization unit 204 may calculate a CP correlation of the reception signal from the small cell base station 100-2 and perform synchronization based on the calculated CP correlation. Note that, in the case where a reception signal at a discrete time k is rₖ, a CP correlation at the discrete time k is able to be obtained, for example, by a following formula (1).

$$\begin{matrix}[ Expression 1 ] & \\ {\sum }_{i = 0}^{{N}_{1}} {\sum }_{τ = 0}^{{N}_{G}} {r}_{k + τ - i ( N + {N}_{G} )} {r}_{k + τ - i ( N + {N}_{G} )}^{*} & ( 1 )\end{matrix}$$

N_{G} is the number of samples of the CP, N is the number of samples of the effective symbol of the OFDM, and N_{I} is the number of symbols of the OFDM used for averaging processing of the CP correlation. Note that, the synchronization unit 204 may perform synchronization by using the CRS included in the reception signal from the small cell base station 100-2.

The synchronization unit 204 outputs the reception signal subjected to synchronization to the CP removal unit 205. The synchronization unit 204 is able to perform synchronization with the small cell base station 100-2 by using synchronization information with the macro cell base station 100-1.

The CP removal unit 205 removes the CP from the reception signal subjected to synchronization processing, which is input from the synchronization unit 204. The CP removal unit 205 outputs the signal from which the CP is removed to the FFT unit 206.

The FFT unit 206 performs FFT for the signal from which the CP is removed, which is input from the CP removal unit 205, and generates reception signals of a frequency region. Of the generated reception signals of the frequency region, the FFT unit 206 outputs the modulation symbol to the demodulation unit 209, outputs a reception signal of the RE to which the DMRS is transmitted to the channel estimation unit 207, and outputs a control signal to the control information detection unit 208.

The channel estimation unit 207 performs channel estimation by using the RE to which the DMRS is transmitted, which is input from the FFT unit 206. The channel estimation unit 207 outputs a channel estimation value to the demodulation unit 209.

The control information detection unit 208 detects control information included in the reception signal. Specifically, the control information detection unit 208 extracts various information such as RB assignment information, MCS (Modulation and Coding Scheme) information, HARQ (Hybrid Automatic Repeat reQuest) information, TPC (Transmit Power Control) information, which are included in the control information. The control information detection unit 208 outputs each information which is extracted to the demodulation unit and the decoding unit.

The demodulation unit 209 performs demodulation processing for the RE to which the modulation symbol is transmitted, which is input from the FFT unit 206, based on the channel estimation value which is input from the channel estimation unit 207 and the control information which is input from the control information detection unit 208. Specifically, the demodulation unit 209 is able to realize the demodulation processing by performing filtering based on ZF (Zero Forcing) and MMSE (Minimum Mean Square Error). Further, in the case of communication using the MIMO scheme, the demodulation unit 209 is able to realize the demodulation processing by using MLD (Maximum Likelihood Detection). The demodulation unit 209 outputs a hard decision value or a soft decision value as a demodulation result.

The decoding unit 210 performs decoding by using the demodulation result which is input from the demodulation unit 209. The decoding unit 210 is able to perform the decoding by using a maximum likelihood decoding method, maximum a posteriori probability (MAP), log-MAP, Max-log-MAP, SOVA (Soft Output Viterbi Algorithm), Sum-Product, or the like. Decoded data includes the terminal information request from the macro cell base station 100-1 (step s103 of FIG. 7). The decoded data includes small cell information notification from the macro cell base station 100-1. In the case where the terminal information request is received or in the case where the small cell information notification is received, the reception quality calculation unit 211 operates. If not, the decoded data is output to the physical layer control unit 212.

In the case where the decoding unit 210 receives the terminal information request from the macro cell base station 100-1, the reception quality calculation unit 211 calculates terminal information by using a reception signal from the surrounding small cell base station. In the case where the terminal information is electric power of the reception signal from the small cell base station, the reception quality calculation unit 211 measures electric power of the reception signal from the surrounding small cell base station. Specifically, the reception quality calculation unit 211 is able to measure reception electric power from a known signal included in the reception signal from the small cell base station.

Note that, the CSI-RS is usable for the known signal. Moreover, the PSS or the SSS may be used. Further, the CRS may be used. In addition, in the case where the terminal information is a position of the terminal 200, the reception quality calculation unit 211 measures position information of the terminal 200. In the case where the decoding unit 210 receives the small cell information notification from the macro cell base station 100-1, the reception quality calculation unit 211 calculates reception quality with respect to the small cell base station 100-2.

The physical layer control unit 212 outputs downlink information data which is input from the decoding unit 210 and the terminal information or the reception quality which is input from the reception quality calculation unit 211 to the higher layer 213. Moreover, the physical layer control unit 212 generates control information from the terminal information or the reception quality to output to the control signal generation unit 221.

The higher layer 213 sets data to be transmitted to each base station as uplink information data and outputs the uplink information data to the data signal generation unit 222. Here, in the case of notifying the base station of the terminal information or the reception quality, the higher layer 213 causes it to be included in the uplink information data.

The control signal generation unit 221 applies error correction coding and modulation mapping to the control information which is input from the physical layer control unit 212 and generates a control signal. The control signal generation unit 221 outputs the generated control signal to the transmission unit 223.

The data signal generation unit 222 applies error correction coding and modulation mapping to the uplink information data which is input from the higher layer 213 and generates an uplink data signal. The data signal generation unit 222 outputs the generated uplink data signal to the transmission unit 223.

The transmission unit 223 performs D/A conversion for the control signal which is input from the control signal generation unit 221 and the uplink data signal which is input from the data signal generation unit 222 and generates an analog signal. The transmission unit 223 applies a band limit to the generated analog signal by filtering processing. The transmission unit 223 up-converts the analog signal to which the band limit is applied into a radio frequency band to transmit from the transmit antenna 224.

In this manner, according to the present embodiment, since the number of the DMRSs mapped per the RB in the transmission signal from the small cell base station is able to be made smaller than the number of the DMRSs mapped per the RB by the macro cell base station, it is possible to significantly improve transmission efficiency between the small cell base station and the terminal.

Note that, though description has been given for the case where the small cell base station 100-2 has the CRS arranged in the same manner as the macro cell base station 100-1 in the aforementioned first embodiment, the small cell base station 100-2 may assign resources for the CRS to a data signal. This makes it possible to further improve transmission efficiency. This is able to be realized by arranging such that all terminals connected with the small cell base station 100-2 use the DMRS.

Note that, though description has been given for the case of the downlink in the aforementioned first embodiment, the same is also applied to the uplink. For example, the terminal 200 is able to make the number of reference signals mapped per one resource block in the case of performing communication with the small cell base station 100-2 smaller than the number of reference signals mapped per one resource block in the case of performing communication with the macro cell base station 100-1.

### Second Embodiment

In the present embodiment, description will be given for a method that a small cell base station transmits a CRS with the number less than the number of CRSs per an RB, which are transmitted by a macro cell base station. In the following description, the macro cell base station 100-1 is the same as that of the first embodiment. Moreover, the small cell base station according to the present embodiment is referred to as a small cell base station 100-3. Moreover, a terminal connected with the small cell base station 100-3 is referred to as a terminal 300.

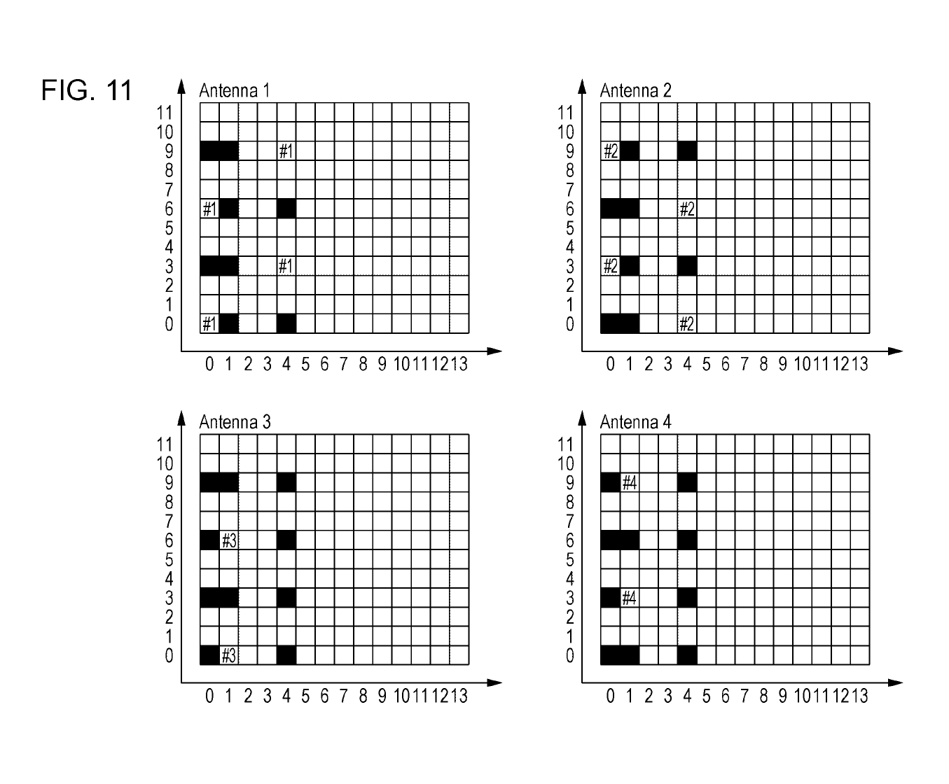

FIG. 11 is a schematic view showing one example of a format of an RB which is transmitted by the small cell base station 100-3 according to the present embodiment. Comparing FIG. 11 with FIG. 3, the number of CRSs per the RB is less in FIG. 11. This makes it possible to improve transmission efficiency. Since it is assumed that the small cell has a narrow coverage and does not cause a long delay wave, in this case, accuracy of channel estimation is hardly deteriorated.

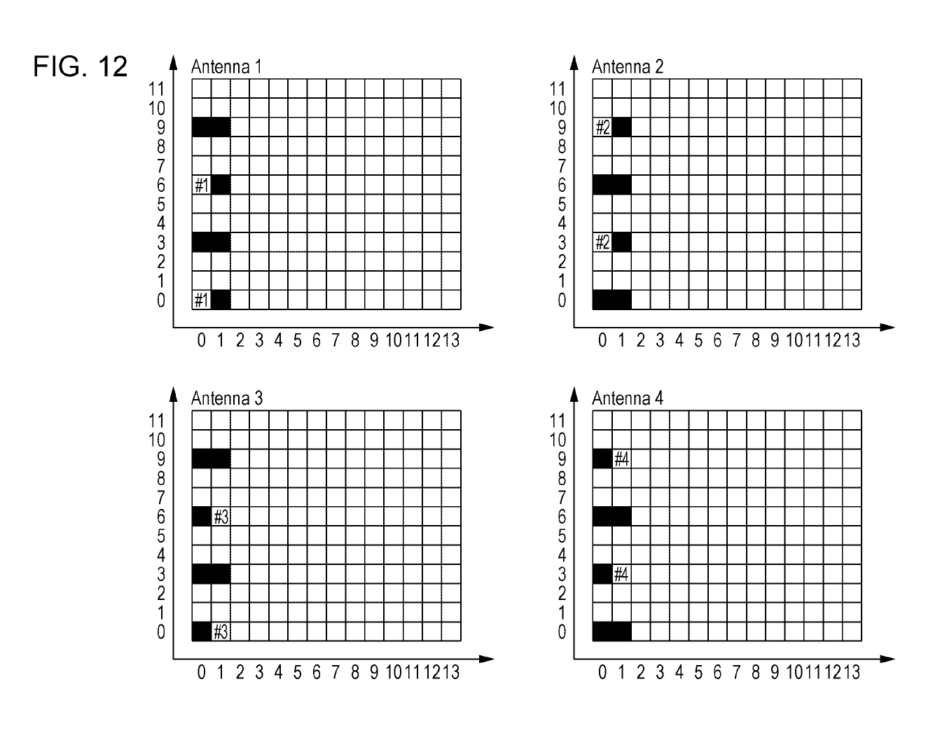

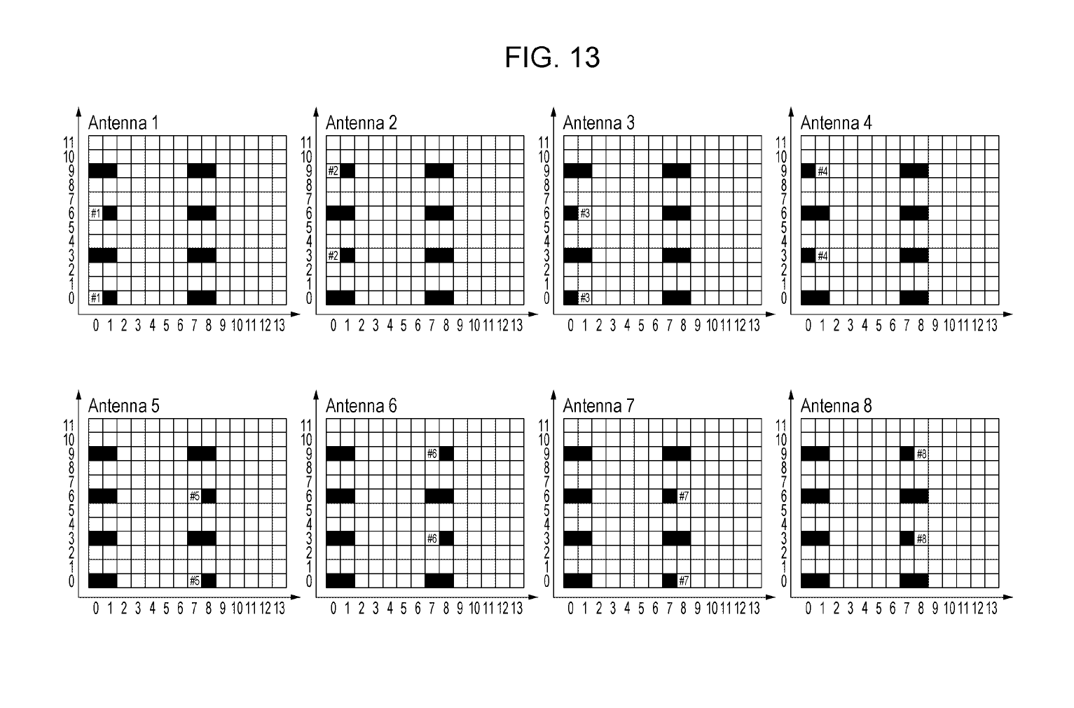

FIG. 12 is a schematic view showing another one example of the format of the RB which is transmitted by the small cell base station 100-3 according to the present embodiment. In FIG. 13, much more REs are assigned to information data, thus making it possible to further improve transmission efficiency.

FIG. 13 is a schematic view showing one example of the format of the RB in the case where the number of transmit antennas that the CRS is able to deal with is increased up to eight. In such a case, the DMRS may not be transmitted to all users.

Note that, in the case where the number of transmit antennas included in the small cell base station 100-3 is smaller than eight, positions of the null may be reduced.

Note that, configurations of the CRS which is transmitted by the small cell base station 100-3 have been described in FIG. 11 through FIG. 13, but without limitation thereto, the present invention is applied as long as the number of CRSs per the RB of each transmit antenna is smaller than that of the macro cell base station 100-1. In this case, frequencies or time positions for arranging the CRSs may be different.

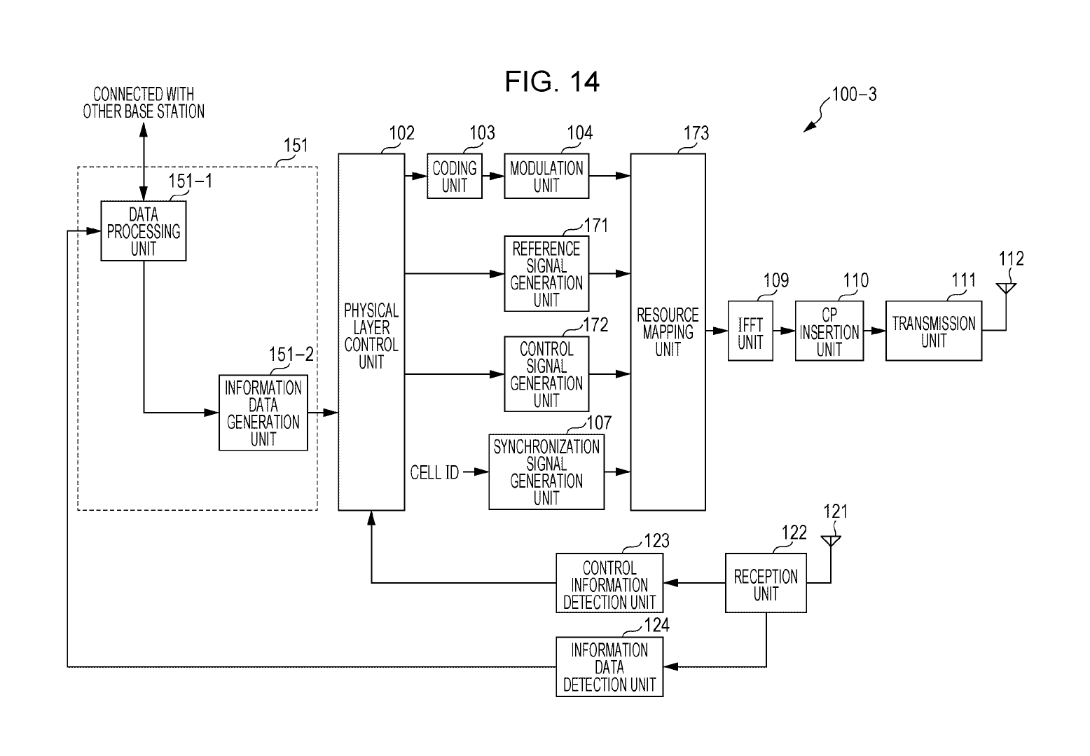

FIG. 14 is a schematic block diagram showing a configuration of the small cell base station 100-3 according to the present embodiment. Comparing the small cell base station 100-3 according to the present embodiment with the small cell base station 100-2 according to the first embodiment (FIG. 9), a reference signal generation unit 171, a control signal generation unit 172 and a resource mapping unit 173 are different. However, functions included in other functions are the same as those in the first embodiment. In the following description, description will be given mainly for functions different from those of the first embodiment.

The reference signal generation unit 171 generates the CRS for the small cell. The reference signal generation unit 171 outputs the generated CRS to the resource mapping unit 173. The reference signal generation unit 171 generates the DMRS for a terminal which uses the DMRS. The reference signal generation unit 171 outputs the generated DMRS to the resource mapping unit 173.

The control signal generation unit 172 has a function of generating arrangement information of the CRSs in addition to the function included in the control signal generation unit 106 according to the macro cell base station 100-1. Note that, arrangement of the CRSs transmitted by the small cell base station 100-3 may be fixed and the control signal generation unit 172 may not generate arrangement information of the CRSs.

The resource mapping unit 173 performs mapping for the modulation symbol, the control signal and the synchronization signal into REs based on resource assignment information which is generated by the control information generation unit 172.

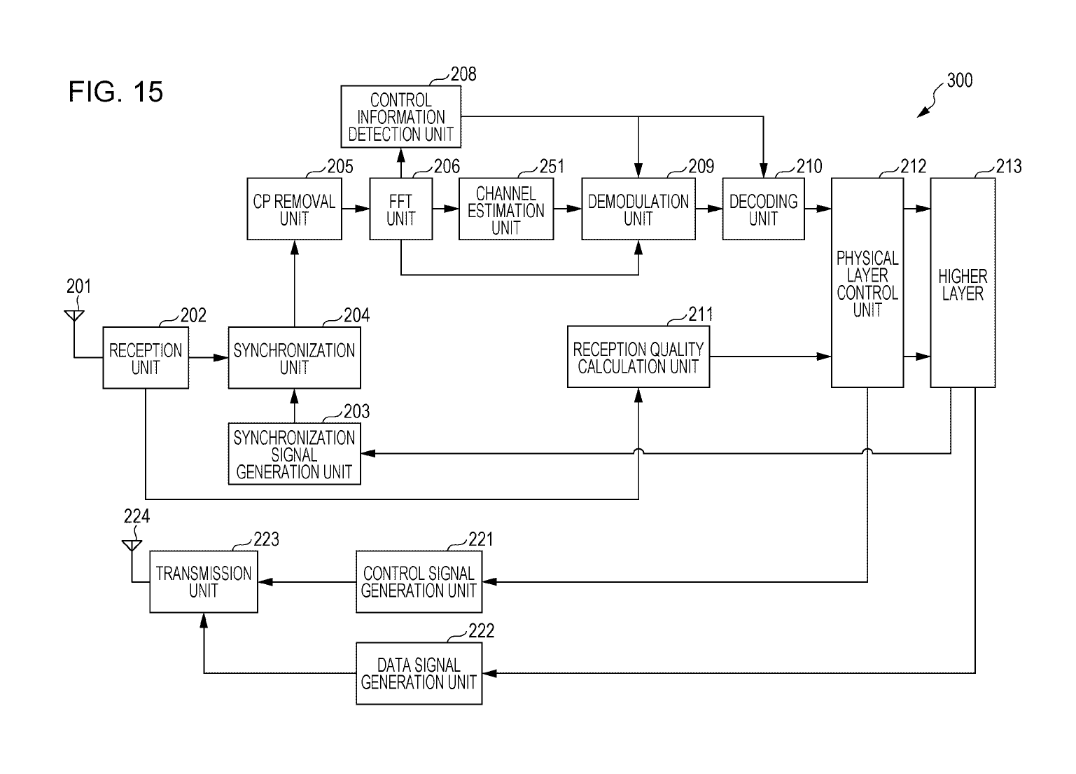

FIG. 15 is a schematic block diagram showing a configuration of the terminal 300 according to the present embodiment. Comparing the terminal 300 according to the present embodiment (FIG. 15) with the terminal 200 according to the first embodiment (FIG. 10), a channel estimation unit 251 is different. Functions included in other blocks are the same as those of the first embodiment. Description will be given below mainly for operation different from that of the first embodiment.

The channel estimation unit 251 performs channel estimation by using the CRS which is transmitted by the small cell base station 100-3. The channel estimation unit 253 outputs a channel estimation value which is calculated to the demodulation unit 209.

In this manner, according to the present embodiment, by transmitting the CRSs with the number less than the number of the CRSs transmitted by the macro cell base station per the transmit antenna in transmission signals from the small cell base station, it is possible to increase the number of REs used for data transmission and significantly improve transmission efficiency. Moreover, since the CRSs are inserted in an entire band, it is possible to improve accuracy of channel estimation by performing channel estimation by using also a band which is not a band assigned for each user in an environment having less delay wave like the small cell.

Note that, though description has been given for the case where the CRSs transmitted by the small cell base station 100-3 are multiplexed up to eight of the number of transmit antennas by using the null in the aforementioned second embodiment, it may be less than eight. For example, in the case where the small cell base station 100-3 has eight transmit antennas, the CRSs to be transmitted may be multiplexed up to the fourth transmit antenna. At this time, it is needless to say that the small cell base station 100-3 has the number of the CRSs to be transmitted per the transmit antenna smaller than that of the macro cell base station 100-1. Further, the DMRSs may be multiplexed so that a terminal allows channel estimation of channels from the remaining four transmit antennas. In this case as well, the number of the DMRSs transmitted by the small cell base station 100-3 per the RB may be set to be less than the number of the DMRSs transmitted by the macro cell base station 100-1 per the RB in the same manner as the first embodiment.

Note that, the transmit antenna multiplexing of the CRSs may be performed by using coding.

### Third Embodiment

In the present embodiment, description will be given for a case where the small cell base station 100-2 according to the first embodiment and the small cell base station 100-3 according to the second embodiment are mixed in a communication system. Note that, a terminal according to the present embodiment is referred to as a terminal 400.

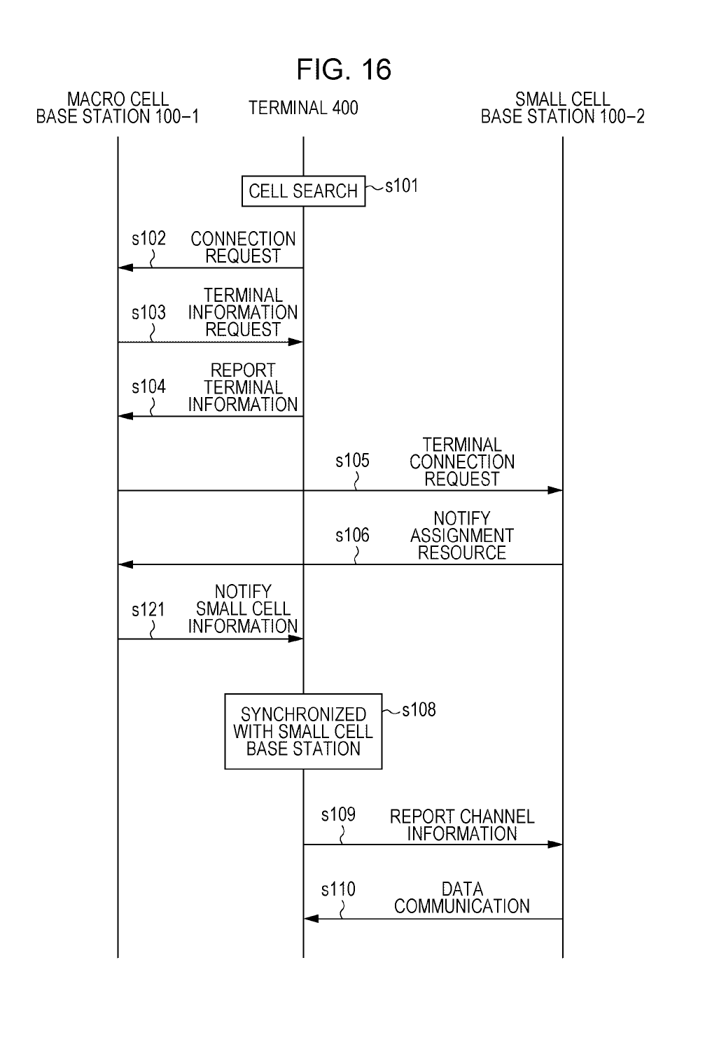

FIG. 16 is a sequence diagram showing a flow of processing of the communication system in a third embodiment. FIG. 16 is one example of processing until the terminal 400 is connected with the small cell base station 100-2 to start data communication with the small cell base station 100-2. Note that, FIG. 16 is applicable also in the case where the terminal 400 is connected with the small cell base station 100-3. Comparing the sequence diagram according to the present embodiment (FIG. 16) with the sequence diagram according to the first embodiment (FIG. 7), small cell information notification (step s121) is different. Other steps are the same as those of the first embodiment. Description will be given below mainly for operation different from that of the first embodiment.

At step s121, the small cell information notification from the macro cell base station 100-1 to the terminal 400 includes identification information as to whether the small cell base station to be connected with the terminal 400 is the small cell base station 100-2 or the small cell base station 100-3. For example, small cell information which is notified by the macro cell base station 100-1 to the terminal 400 is able to include the identification information. The identification information allows that 0 serves as information showing being the small cell base station 100-2 and 1 serves as information showing being the small cell base station 100-3, for example, by using 1 bit.

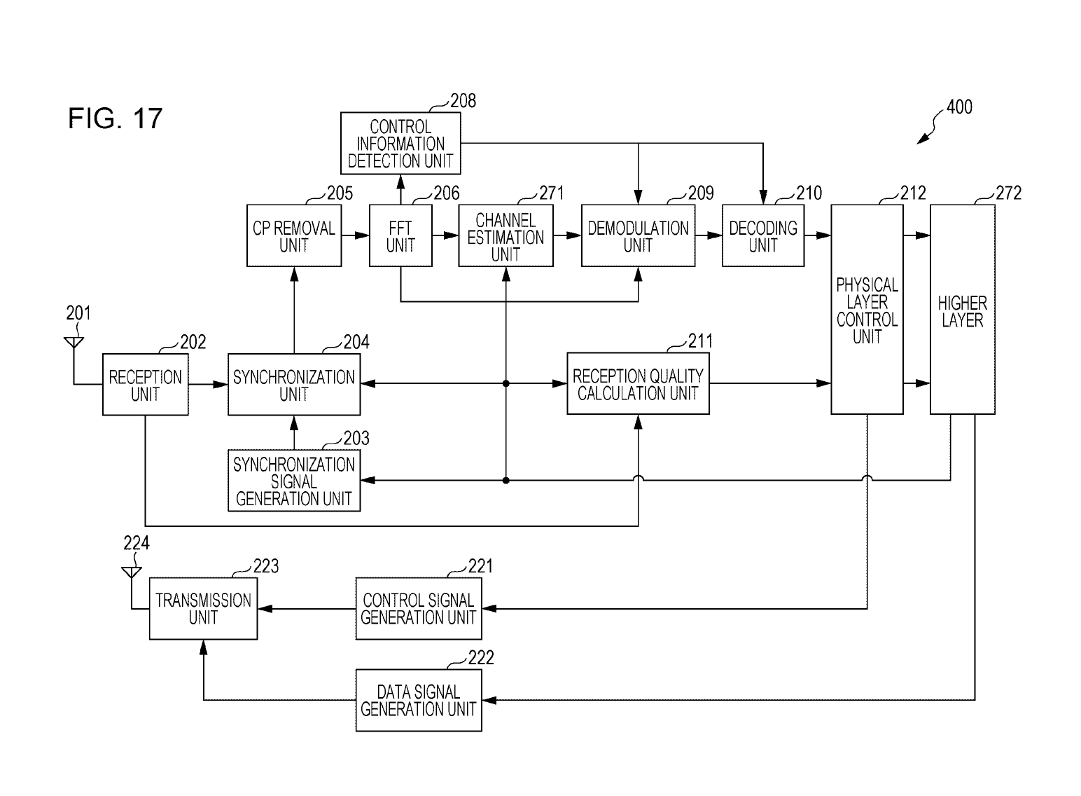

FIG. 17 is a schematic block diagram showing a configuration of the terminal 400 according to the third embodiment. Comparing the terminal 400 (FIG. 17) with the terminal 200 according to the first embodiment (FIG. 10), a channel estimation unit 271 and a higher layer 272 are different. Functions included in other blocks are the same as those of the first embodiment. Description will be given below mainly for operation different from that of the first embodiment.

In the case where the identification information of the small cell base station, which is input from the higher layer 272, is the small cell base station 100-2, the channel estimation unit 271 operates in the same manner as the channel estimation unit 207 (FIG. 10). In the case where the identification information of the small cell base station, which is input from the higher layer 275, is the small cell base station 100-3, the channel estimation unit 273 operates in the same manner as the channel estimation unit 251 (FIG. 15).

The higher layer 272 has a function of extracting the identification information of the small cell base station as the small cell information notification from the macro cell base station 100-1 in addition to the function included in the higher layer 213 (FIG. 10). Whether the small cell base station which is instructed to be connected with the terminal 400 is the small cell base station 100-2 or 100-3 as a result of the extraction is notified to the channel estimation unit 271.

In this manner, according to the present embodiment, it is possible to establish the communication system in which the small cell base station 100-2 according to the first embodiment and the small cell base station 100-3 according to the second embodiment are mixed. For example, it is possible to arrange the small cell base station 100-2 in an environment with many delay waves and arrange the small cell base station 100-3 in an environment with few delay waves by considering that a multipath environment varies according to a land form. This makes it possible to improve accuracy of channel estimation of the terminal 400 and significantly improve transmission efficiency.

A program related to the present invention, which operates in the macro cell base station 100-1, the small cell base stations 100-2 and 100-3, and the terminals 200, 300 and 400 is a program which controls a CPU and the like (program that functions a computer) so as to realize functions of the aforementioned embodiments related to the present invention. In addition, information which is handled by these devices is temporarily accumulated in a RAM at the time of processing thereof, and then stored in various ROMs or an HDD, and is read, modified, and written by the CPU as desired. A recording medium in which the program is stored may be any of a semiconductor medium (for example, such as a ROM or a non-volatile memory card), an optical recording medium (for example, such as a DVD, an MO, an MD, a CD or a BD), a magnetic recording medium (for example, such as a magnetic tape or a flexible disc), and the like. Moreover, not only are the functions of the aforementioned embodiments realized by executing the loaded program, but the functions of the present invention may also be realized by processing in conjunction with an operating system, another application program or the like based on an instruction from this program.

In addition, in the case of distributing to the marketplace, the program can be stored on a portable recording medium and distributed, or transferred to a server computer which is connected via a network such as the Internet. In this case, a storage device of the server computer is also included in the present invention. Moreover, a part of or all of the macro cell base station 100-1, the small cell base stations 100-2 and 100-3, and the terminals 200, 300 and 400, which have been described by using drawings in the aforementioned embodiments, may be realized typically as an LSI which is an integrated circuit. Each functional block of the macro cell base station 100-1, the small cell base stations 100-2 and 100-3, and the terminals 200, 300 and 400 may be chipped individually, or a part or all thereof may be chipped being integrated. Further, a method for making into an integrated circuit is not limited to the LSI and a dedicated circuit or a versatile processor may be used for realization. Further, in case a technology for making into an integrated circuit in place of the LSI appears with advance of a semiconductor technology, an integrated circuit by this technology may be also used.

As above, the embodiments of this invention have been described in detail with reference to drawings, but specific configurations are not limited to these embodiments, and design change and the like which are not departed from the gist of this invention are also included. Moreover, as for the present invention, various modifications are possible in the scope indicated in Claims, and an embodiment acquired by combining appropriately technical means each disclosed in a different embodiment is also included in the technical scope of the present invention. Further, a configuration where elements which are described in each of the aforementioned embodiments and which exert the same effect are replaced mutually is also included.

Note that, the invention of the present application is not limited to the aforementioned embodiments. The terminal device of the invention of the present application is not limited to be applied to a mobile station device, and, needless to say, applicable to stationary or non-movable electronic equipment which is installed indoors or outdoors, for example, including AV equipment, kitchen equipment, cleaning/washing equipment, air-conditioning equipment, office equipment, an automatic vending machine, and other household equipment.

### INDUSTRIAL APPLICABILITY

The present invention is suitably used for a base station device, a terminal device, a communication system, a transmission method, a reception method and a communication method.

### REFERENCE SIGNS LIST

100-1, 1000-1 macro cell base station device
100-1a, 1000-1a macro cell
100-2, 100-3, 1000-2, 1000-3 small cell base station device
100-2a, 1000-2a, 1000-3a small cell
200, 2000-1, 2000-2, 2000-3 terminal device
101, 151, 213, 272 higher layer
101-1, 151-1 data processing unit
101-2 small cell base station determination unit
101-3, 151-2 information data generation unit
102 physical layer control unit
103 coding unit
104 modulation unit
105, 152, 171 reference signal generation unit
106, 153, 221, 172 control signal generation unit
107 synchronization signal generation unit
108, 154, 173 resource mapping unit
109 IFFT unit
110 CP insertion unit
111, 223 transmission unit
112, 224 transmit antenna
121, 201 receive antenna
122, 202 reception unit
123 control information detection unit
124 terminal information detection unit
203 synchronization signal generation unit
204 synchronization unit
205 CP removal unit
206 FFT unit
207, 251, 271 channel estimation unit
208 control information detection unit
209 demodulation unit
210 decoding unit
211 reception quality calculation unit
212 physical layer control unit
222 data signal generation unit
1000-2b, 1000-3b line

1-19. (canceled)

20. A base station device that communicates with a terminal device together with a different base station device, wherein
a number of reference signals mapped per one resource block by itself is less than a number of reference signals mapped per one resource block by the different base station device.

21. The base station device according to claim 20, wherein the reference signals are user-specific reference signals.

22. The base station device according to claim 20, wherein the reference signals are cell-specific reference signals.

23. The base station device according to claim 20, wherein a frequency interval of the reference signals mapped by itself is wider than a frequency interval of the reference signals mapped by the different base station device.

24. The base station device according to claim 20, wherein a time interval of the reference signals mapped by itself is longer than a time interval of the reference signals mapped by the different base station device.

25. A terminal device that communicates with a first base station device and a second base station device, wherein
a number of reference signals mapped per one resource block in communication with the second base station device is less than a number of reference signals mapped per one resource block in communication with the first base station device.

26. The terminal device according to claim 25, wherein the reference signals are reference signals of downlink.

27. The terminal device according to claim 25, wherein the reference signals are reference signals of uplink.

28. The terminal device according to claim 25, comprising a control information detection unit that receives arrangement information of the reference signals mapped by the second base station device from the first base station device.

29. The terminal device according to claim 25, wherein the reference signals are user-specific reference signals.

30. The terminal device according to claim 25, wherein the reference signals are cell-specific reference signals.

31. The terminal device according to claim 25, wherein a frequency interval of the reference signals mapped by the second base station device is wider than a frequency interval of the reference signals mapped by the first base station device.

32. The terminal device according to claim 25, wherein a time interval of the reference signals mapped by the second base station device is longer than a time interval of the reference signals mapped by the first base station device.

33. A communication method in a terminal device that communicates with a first base station device and a second base station device, wherein
a number of reference signals mapped per one resource block in communication with the second base station device is less than a number of reference signals mapped per one resource block in communication with the first base station device.
